(19) United States
(12) Patent Application Publication
(10) Pub. No.: US 2003/0149592 A1
(43) Pub. Date: Aug. 7, 2003

(54) Patient qualifying and selection process

(76) Inventors: Linda L. Roman, Boca Raton, FL (US); Vincient Colwell, Martinez, GA (US); Suzette DiMascio, Orlando, FL (US); Patty Foster, Antioch, CA (US); Rose Cox, Germantown, TN (US); Donna M. Mongiello, Germantown, TN (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/904,350

(22) Filed: Jul. 12, 2001

(51) Int. Cl. G06F 17/60

(52) U.S. Cl. 705/2

(57) ABSTRACT

A method, system, and computer system for qualifying and selecting patients that are to be included in the electronic house call program are disclosed. A method to qualify and select patients to be included in the electronic house call program includes receiving an input that is associated with a patient. The input is assessed using at least one qualifying module, where the qualifying module has at least one predetermined parameter. Thereafter, a determination is made to determine if the input is a qualified input. Then the patient associated with a qualified input is enrolled into the electronic house call program.

### CROSS-REFERENCE TO RELATED APPLICATIONS

This application is related to U.S. Pat. No. 5,987,519 entitled, “TELEMEDICINE SYSTEM USING VOICE VIDEO AND DATA ENCAPSULATION AND DE-ENCAPSULATION FOR COMMUNICATING MEDICAL INFORMATION BETWEEN CENTRAL MONITORING STATIONS AND REMOTE PATIENT MONITORING STATIONS,” filed on Sep. 19, 1997, which is entirely incorporated herein by reference.

### FIELD OF INVENTION

This invention relates to processes for selecting patients and, more particularly, processes used for qualifying and selecting patients for technology-assisted disease management.

### BACKGROUND

The advent of the information age is slowly making an impact on the way that healthcare is delivered. New, non-traditional methodologies are being tried with varying degrees of success. Broadly, categorized as “telemedicine” these efforts center on using automation, networking and communications technologies to deliver patient care in nontraditional methods settings. Generally the goals of such efforts are to increase access, contain costs, and improve patient quality of life.

Generally, telemedicine is a term used to describe a type of patient care, which involves monitoring of a patient's condition by a healthcare worker located at a healthcare facility, which is remote with respect to the location of the patient. Telemedicine, if adequately employed, is capable of providing enormous benefits to society. One such benefit is that patients can be examined without having to travel to a healthcare facility. This feature is particularly important for patients who live in remote areas who may not be able to easily travel to the nearest healthcare facility, or who need to be examined by a healthcare worker located far away from the patient, in another state, for example.

Another benefit of telemedicine is that it is capable of allowing a patient to be examined more often than would be possible if the patient were required to travel to a healthcare facility due to the ease with which it can be administered. For example, if a patient's condition requires that measurements be taken several times a day, it would be impractical for the patient to travel to and from a healthcare facility each time a measurement needs to be taken. It probably would be necessary for the patient to be admitted to the healthcare facility. The use of telemedicine could allow these measurements to be taken at the patient's home while the healthcare worker observed the patient or the measurement data from the healthcare facility.

Another benefit of telemedicine is that it allows a patient to be examined in a more timely manner than if the patient was required to travel to the healthcare facility. This is important in urgent situations, such as when a patient's condition becomes critical and emergency procedures must be taken immediately.

The current approaches to technology-assisted patient care have been under the assumption that “one-size-fits-all.” The results have been inconclusive. Assessment of these efforts has been subjective as has patient outcomes and progress towards a specific goal. These goals are not typically standardized and often fluctuate from one care provider to the next based on their interpretations of accepted guidelines.

The telemedicine based patient care management tools that have been developed to date are beginning to recognize that current methods and processes do not address the needs of the diverse pool of patients or the needs of the various types of patient care organizations.

Thus, a heretofore unaddressed need exists in the industry to address the aforementioned deficiencies and inadequacies.

### SUMMARY OF THE INVENTION

The present invention provides, among other things, a method for qualifying and selecting patients that are to be included in a technology-assisted disease management system.

An exemplary embodiment provides for a method to qualify and select patients to be included in the technology-assisted disease management system. The method includes receiving an input that is associated with a patient. The input is assessed using at least one qualifying module, where the qualifying module has at least one predetermined parameter. Thereafter, a determination is made to determine if the input is a qualified input. Then, the patient associated with a qualified input is included in the technology-assisted disease management system.

Further, another exemplary embodiment of the method includes the step of re-evaluating non-qualified inputs. Then, the method determines if the non-qualified input is a re-evaluated qualified input. The method includes the patient associated with the re-evaluated qualified input in the technology-assisted disease management system.

Furthermore, still another exemplary embodiment of the method includes the step of receiving a qualified outcome input associated with the patient outcome of being included in the technology-assisted disease management system and assessing the outcome qualified input to determine if it is unsatisfactory. The determination is based upon the patient outcome after being included in the technology-assisted disease management system. Thereafter, the method resets at least one of the parameters if the qualified outcome input is determined to be unsatisfactory.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 illustrates an exemplary computer system that can implement the patient qualifying and selection process.

FIG. 2 illustrates a flow chart of an overview of an embodiment of the patient qualifying and selection process.

FIG. 3 illustrates a flow chart that depicts some of the specific modules of the patient qualifying and selection process of an embodiment of the present invention, as shown in FIG. 1.

FIG. 4 illustrates a flow chart that depicts the global goals module of an embodiment of the present invention as shown in FIG. 1.

FIGS. 5A-5C illustrates a flow chart that depicts the patient scoring module of an embodiment of the present invention as shown in FIG. 1.

FIGS. 6A-6B illustrates a flow chart that depicts the intervention goals and outcomes module of an embodiment of the present invention as shown in FIG. 1.

### DETAILED DESCRIPTION OF THE PREFERRED EMBODIMENT

Embodiments of the present invention provide for a method, system, and computer system which help care providers determine if a patient should be managed using a telemedicine system, hereinafter a technology-assisted disease management system (TADM), and indicate which patient management device of the TADM system can provide the sought after results. An embodiment of the present invention includes the patient qualifying and selection process, which can be used by care provider organizations to properly qualify patients to be included in the TADM system.

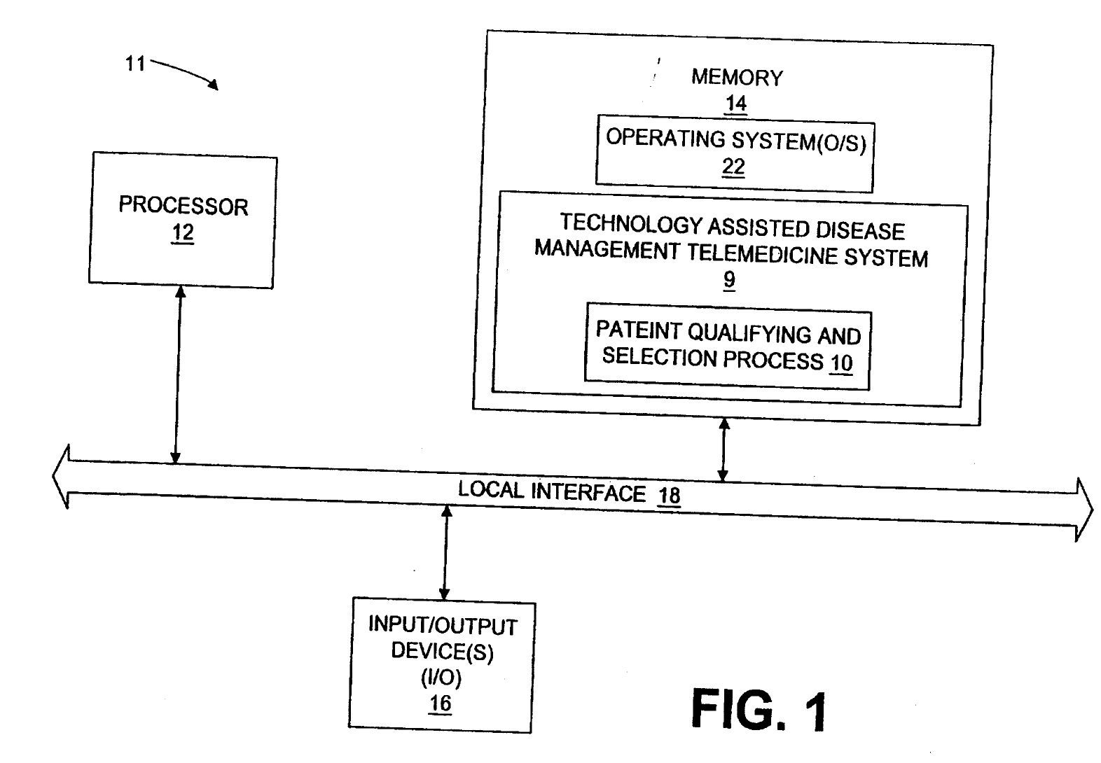

The patient qualifying and selection process of the invention can be implemented in software (e.g., firmware), hardware, or a combination thereof. In the currently contemplated best mode, the patient qualifying and selection process is implemented in software, as an executable program, and is executed by a special or general purpose digital computer, such as a personal computer (PC; IBM-compatible, Apple-compatible, or otherwise), workstation, minicomputer, or mainframe computer. An example of a general purpose computer that can implement the patient qualifying and selection process of the present invention is shown in FIG. 1. In FIG. 1, the patient qualifying and selection process is denoted by reference numeral 10 and is a module of the TDAM system 9.

Generally, in terms of hardware architecture, as shown in FIG. 1, the computer 11 includes a processor 12, memory 14, and one or more input and/or output (I/O) devices 16 (or peripherals) that are communicatively coupled via a local interface 18. The local interface 18 can be, for example but not limited to, one or more buses or other wired or wireless connections, as is known in the art. The local interface 18 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 12 is a hardware device for executing software that can be stored in memory 14. The processor 12 can be any custom made or commercially available processor, a central processing unit (CPU) or an auxiliary processor among several processors associated with the computer 11, and a semiconductor based microprocessor (in the form of a microchip) or a macroprocessor. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc, or a 68xxx series microprocessor from Motorola Corporation.

The memory 14 can include any one or combination of volatile memory elements (e.g., random access memory (RAM, such as DRAM, SRAM, etc.)) and nonvolatile memory elements (e.g., ROM, hard drive, tape, CDROM, etc.). Moreover, the memory 14 may incorporate electronic, magnetic, optical, and/or other types of storage media. Note that the memory 14 can have a distributed architecture, where various components are situated remote from one another, but can be accessed by the processor 12.

The software in memory 14 may include one or more separate programs, each of which comprises an ordered listing of executable instructions for implementing logical functions. In the example of FIG. 1, the software in the memory 14 includes the patient qualifying and selection process and a suitable operating system (O/S) 22. A nonexhaustive list of examples of suitable commercially available operating systems 22 is as follows: a Windows operating system from Microsoft Corporation, a Netware operating system available from Novell, Inc., or a UNIX operating system, which is available for purchase from many vendors, such as Hewlett-Packard Company, Sun Microsystems, Inc., and AT&T Corporation. The operating system 22 essentially controls the execution of other computer programs, such as the patient qualifying and selection process 10, and provides scheduling, input-output control, file and data management, memory management, and communication control and related services.

The patient qualifying and selection process 10 can be a source program, executable program (object code), script, or any other entity comprising a set of instructions to be performed. When a source program, then the program needs to be translated via a compiler, assembler, interpreter, or the like, which may or may not be included within the memory 14, so as to operate properly in connection with the O/S 22. Furthermore, the patient qualifying and selection process 10 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices 16 may include input devices, for example but not limited to, a keyboard, mouse, scanner, microphone, etc. Furthermore, the I/O devices 16 may also include output devices, for example but not limited to, a printer, display, etc. Finally, the I/O devices 16 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer 11 is a PC, workstation, or the like, the software in the memory 14 may further include a basic input output system (BIOS) (omitted for simplicity). The BIOS is a set of essential software routines that initialize and test hardware at startup, start the O/S 22, and support the transfer of data among the hardware devices. The BIOS is stored in ROM so that the BIOS can be executed when the computer 11 is activated.

When the computer 11 is in operation, the processor 12 is configured to execute software stored within the memory 14, to communicate data to and from the memory 14, and to generally control operations of the computer 11 pursuant to the software. The patient qualifying and selection process 10 and the O/S 22, in whole or in part, but typically the latter, are read by the processor 12, perhaps buffered within the processor 12, and then executed.

When the patient qualifying and selection process 10 is implemented in software, as is shown in FIG. 1, it should be noted that the patient qualifying and selection process 10 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The patient qualifying and selection process 10 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the patient qualifying and selection process 10 is implemented in hardware, the patient qualifying and selection process can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The patient qualifying and selection process 10 (hereinafter PQSP) allows a care provider to use a standardized model for identifying patients for inclusion (enrollment) in the TADM system 9. Once a patient is enrolled into the TADM system 9, the patient is capable of participating in the treatment and monitoring program offered by the TADM system 9. In addition, embodiments of the PQSP 10 can provide an automated decision support system for selecting the monitoring equipment best for a particular patient. Further, embodiments of the PQSP 10 allow for standardized scoring criteria for patients and re-evaluating patients. Furthermore, embodiments of the PQSP 10 allow care providers to set goals and objectives appropriate for, but not limited to, qualified patients, disease categories, and organizational requirements.

Embodiments of the PQSP 10 provide a standardized, simplified and efficient way for selecting and qualifying patients for the TADM system 9. Embodiments of the PQSP 10 can provide the care provider with the ability to determine long- and short-term goals, score the patient and evaluate the ability of the patient to respond to a disease management regimen. These embodiments enable care providers to decide whether a particular patient can respond to care provided in this manner. In this way, embodiments of the PQSP 10 can assist care providers and the organizations to maximize the return on investment and maximize the patient care outcomes.

Embodiments of the PQSP 10 take advantage of the networked environment of the TADM system 9 to gather information from many different locations to determine the best course of care for a patient. The care provider can then accurately assess and score the patient to determine how the patient can be managed using embodiments of the PQSP 10. The resulting patient score provides an indication of whether the patient can or should be managed using the TADM system 9, traditional methods, or a combination of both methodologies.

Embodiments of the PQSP 10 offer the integrated tools necessary for the care provider and/or physician to evaluate the patient with regard to disease condition, qualification score, the system goals that have been established, and the patient outcome goals that might be achieved. Efficiency can be enhanced because only patients that are most likely to progress in the TADM system 9 are selected by the PQSP 10. Additionally, these embodiments allow the care provider to tailor or customize the right equipment and configuration, right pathway, and right goal for the patient.

Embodiments of the PQSP 10 allow the care provider to use a standardized evidence-based model for identifying patients for enrollment. In addition, these embodiments are on an automated decision support system for selecting the monitoring equipment best for a particular patient. These embodiments use a standardized scoring criterion for evaluating patients. The care provider and/or organization can set goals and objectives in the qualifying modules appropriate for patient and organizational categories.

The ability to objectively qualify patients has an overwhelming effect on the efficacy of the TADM system 9. Embodiments of the PQSP 10 can be used to apply specific and objective criteria to a patient and allow the care provider and the organization to meet larger goals while not compromising patient care. The effect allows the care provider to efficiently apply resources available to achieve the best possible patient outcomes, meet organizational goals, and improve the efficacy of patient care interventions. The more qualified the patient the better the outcome. Patients that do not qualify can either be qualified under another protocol, should not be managed with the TADM system 9, or might not require management at all. Embodiments of the PQSP 10 provide a structured, objective system to select patients for management. The PQSP 10 can also reduce the “failure” rate of patients within the management programs of the organization. These embodiments assist the care provider by identifying likely causes of patient relapses so as to allow focused activities in these areas. Further, these embodiments improve the overall effectiveness of care and efficacy of the management programs of the organization. Furthermore, these embodiments allow for continuous improvement of processes through application analysis and compliance assessment and, if necessary, resetting parameters of the PQSP 10.

Embodiments of the PQSP 10 include both the “front-end” and the “back-end” of the TADM system 9. As the “front-end” of the process, this methodology is the process by which the care provider and their organization can maximize the use of the TADM system 9. As the “back-end” of the process, information on the patient outcomes, organizationally, regionally, or globally, are analyzed and processed to further improve the selection process by resetting appropriate parameters of the PQSP 10.

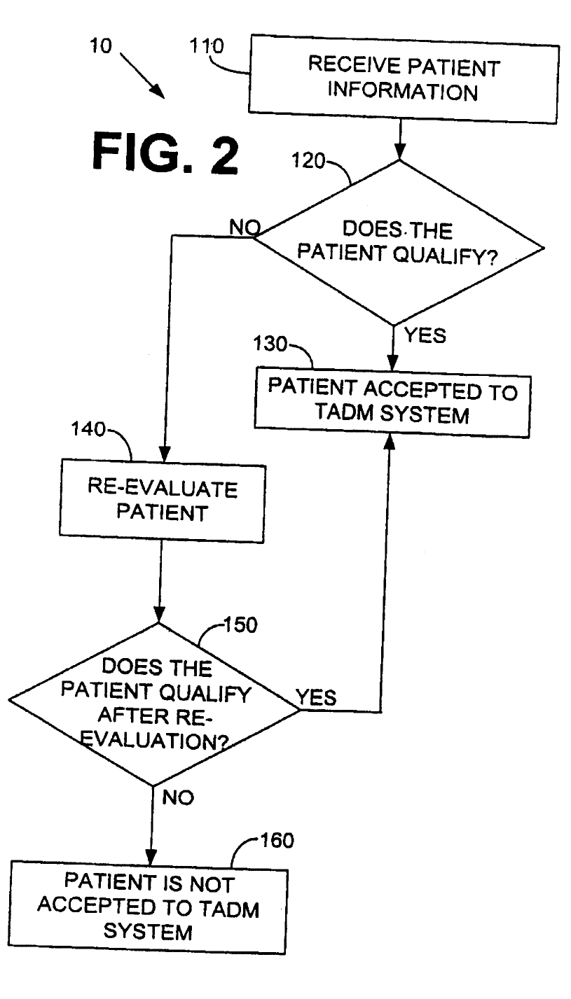

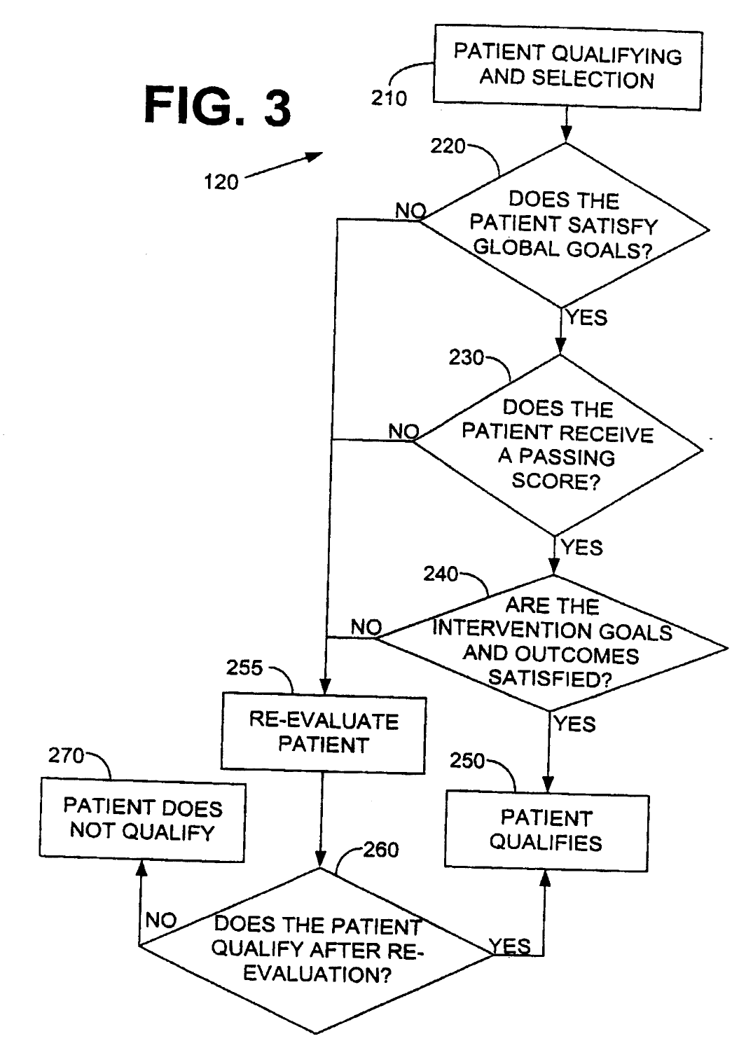

FIG. 2 illustrates an overview of an embodiment of the PQSP 10. This embodiment 10 is capable of operating both in a stand-alone mode and in an interactive, multitasking mode. The PQSP 10 includes one or more modules which include one more parameters or criteria that can be used to evaluate one or more patients. Exemplary embodiments of the modules are illustrated in more detail in FIGS. 3-6.

FIG. 2 illustrates a flow chart of an exemplary embodiment of the PQSP 10 that provides an overview of the PQSP 10. In block 110 the PQSP 10 receives patient information. Next, in decisional block 120 the PQSP 10 determines if the patient qualifies for the TADM system 9. The qualification process modules are elaborated in further detail in FIGS. 3-6. If the determination in block 120 is “yes,” then the patient is accepted into the TADM system 9, block 130. If the determination is “no,” than the patient is re-evaluated, as shown in block 140, which flows into block 150. In decisional block 150, the PQSP 10 determines if the patient qualifies after re-evaluation. If the determination is “yes,” then the patient is accepted (e.g. enrolled and able to participate) into the TADM system 9. If the determination is “no,” then the patient is not accepted into the TADM system 9, block 160. The re-evaluation process can occur after the entire qualification process is complete, after each step of the qualification process (as shown in FIGS. 3-6), or some combination of the two re-evaluation processes listed hereinabove. The organization that is using the TADM system 9 can customize the PQSP 10 as needed by adjusting the qualification process module 120, inputted patient information, patient re-evaluation, etc.

The type of client organization using embodiments of the PQSP 10 are capable of defining the goals to be implemented in the TADM system 9, which are typically based on the business model of the organization. Different types of client organizations have different goals, which changes how an organization applies the TADM system 9 and how they select patients. Client organization categories include, but are not limited to, residential facilities, (e.g. long term care, assisted living, mental health); government, (e.g. medicaid, medicare, VA); acute care facilities, (e.g. hospital systems, community based clinics, urgent care centers); managed care agencies; correctional facilities; retail pharmacy; home health agencies; educational facilities, (e.g. schools of medicine, nursing, allied health sciences or residency programs).

The goals or parameters that are capable of being applied to the PQSP 10 do not specifically differ based on the organizational focus. In general, goals implemented into the TADM system 9 by the PQSP 10 can remain consistent. Priority or emphasis on a specific goal can be arranged in the set-up of the PQSP 10 to suit the needs of the organization and assist in qualifying and selecting patients. Typical goals include, but are not limited to, the following: reduce overall costs, improving cost effectiveness of healthcare delivery, improve quality of healthcare delivered, promote health education, reduce emergency room visits, reduce hospital admissions, maintain highest level of patient functioning, improve medication compliance, enhance psycho-social interactions between patient and healthcare provider, improve utilization of staff through better time management, promote community safety by minimizing off site inmate transport.

Patient sets are assessed by the PQSP 10 based on the goals as determined by the particular organization. The goals of the organization can be implemented by setting appropriate parameters in appropriate PQSP 10 modules, which can be used to assess the patient sets. The modules of the PQSP 10 include, but are not limited to global goals, patient scoring, and intervention goals and outcomes modules. The assessment process determines the potential for a positive outcome with a specific patient, while considering the organizations business model. The process is objective and can use tight definitions and criteria matched with preset scores. Once a patient is assessed the patient can be enrolled into the TADM system 9 if the patient receives a “passing” result. If a patient gets a non-passing result, the patient assessment may be re-evaluated to ensure that no inconsistencies or mistakes have occurred. The case may also be evaluated subjectively to determine whether assessment and scoring represents an accurate presentation of the patient. This second level assessment ensures that all patients are properly considered for enrollment.

An embodiment of the TADM system 9 provides a database with information necessary to qualify and select patients from an organizations master patient list. In general, the database describes the criteria for performing assessments and a mechanism to tailor or customize the process to meet organizational objectives. The database is communicatively coupled to other databases that may include information such as, but not limited to, the number of patient visits to a doctor or hospital, activities to be conducted or performed on the patient, patient scoring criteria, health and education goals of the organization and patient, and expected outcomes desired to be achieved. In addition to patient qualification, an exemplary embodiment of the present invention is capable of incorporating constant feedback from the various modules (e.g. global goals, patient scoring, intervention and outcomes, and any cub-categories of these), thereby enabling the PQSP 10 to continually be updated and allow for the criteria to be amended to allow for better qualification of patients.

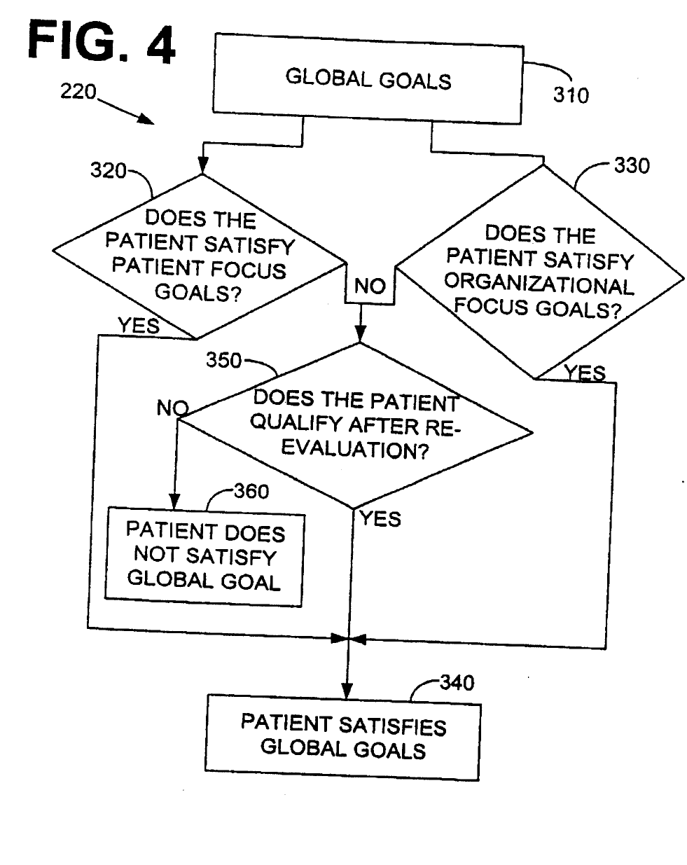

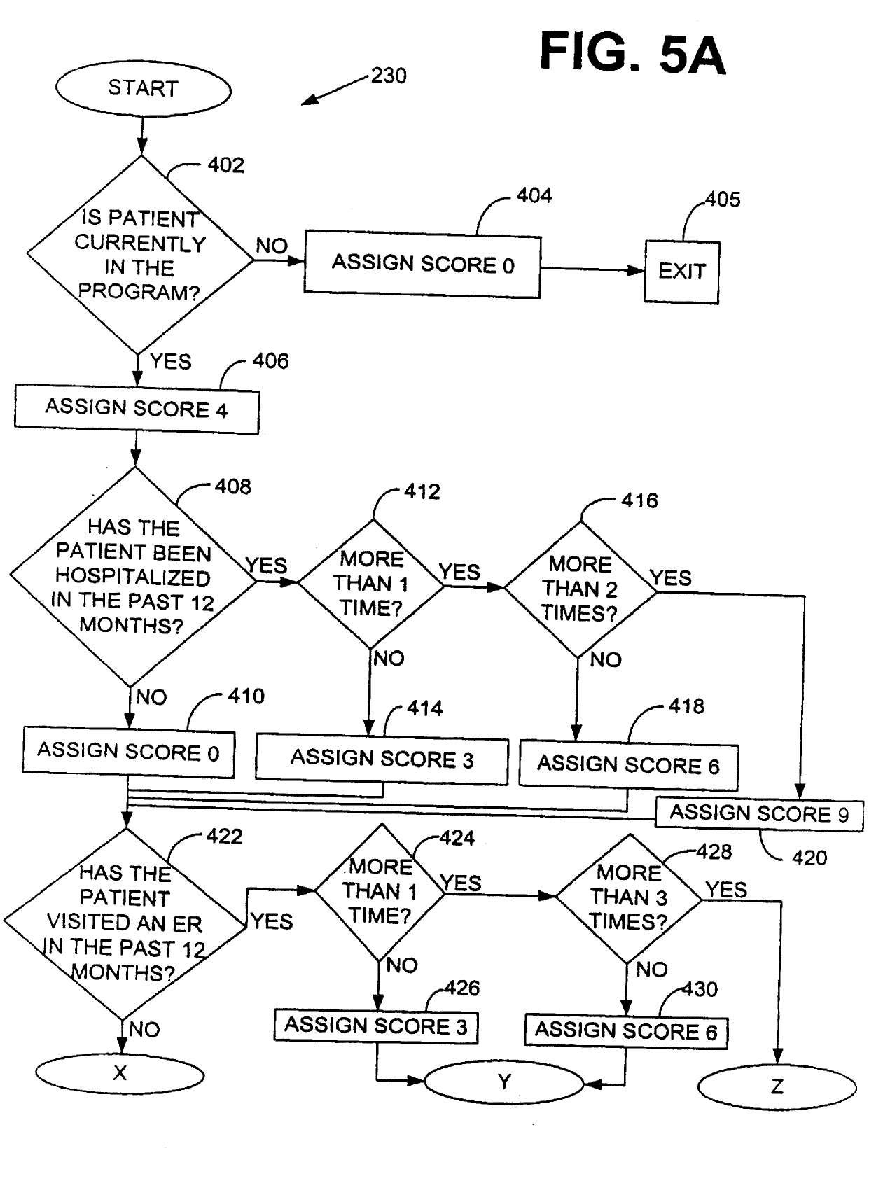

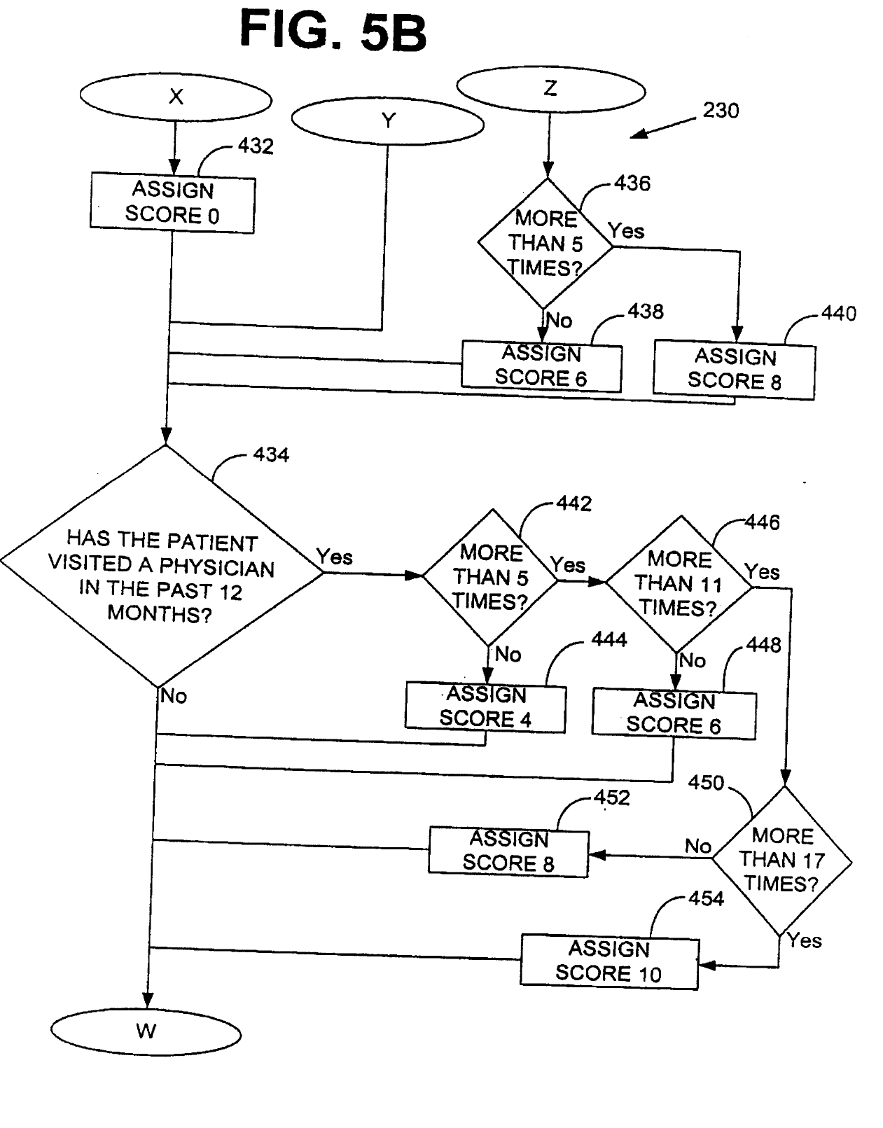

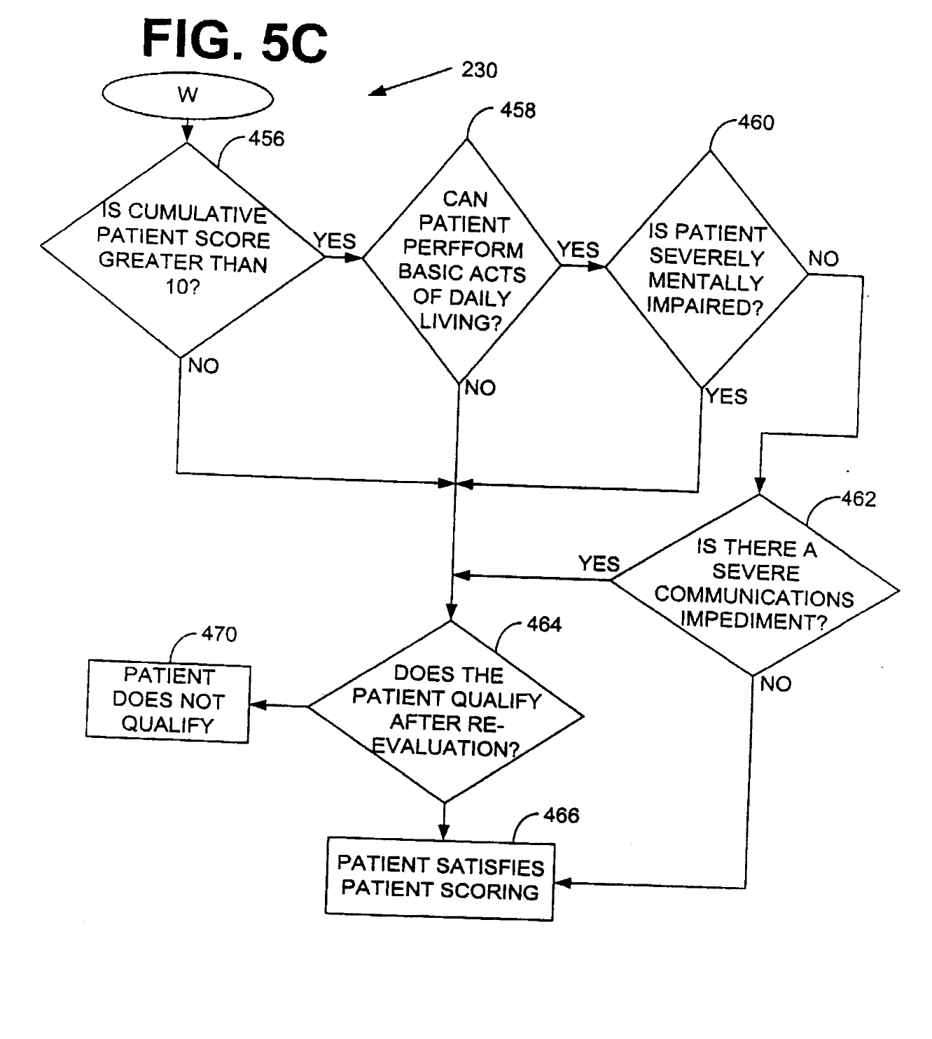

FIG. 3 illustrates a flow chart of an embodiment of the present invention 120 that is a more detailed illustration of the patient qualification process module (PQPM 120) shown in block 120 in FIG. 2. Generally, the PQPM 120 includes determining if the patient satisfies a set of criteria or parameters. The criteria modules include, but are not limited to, global goals 220, patient scoring 230, and intervention goals and outcomes 240. Initially, the PQPM 120 determines if the patient satisfies the global goals 220 (FIG. 3). If the determination is “yes,” then the PQPM 120 continues to decisional block 230. If the determination is “no” then the patient is re-evaluated, as shown in block 255, which is discussed in more detail below. In decisional block 230 a determination is made to ascertain if the patient receives a passing patient score 230 as determined by a patient scoring tool (FIGS. 4A-4C). If the determination is “no,” then the patient is re-evaluated, as shown in block 255. If the determination in block 230 is “yes,” then the PQPM 120 continues to block 240. In block 240, the PQPM 120 determines if the intervention goals and outcomes are satisfied 240 (FIGS. 5A-5B). If the determination in block 240 is “no,” then the patient is re-evaluated, as shown in block 255. If the determination in block 240 is “yes,” then the patient qualifies for the TADM system 9, as shown in block 250. As discussed above, if the patient does not satisfy any one of these criteria, the patient may be re-evaluated, as shown in block 255. The flow chart continues from block 255 to decisional block 260, where the PQPM 120 determines if the patient qualifies after re-evaluation, as shown in block 260. If the determination is “yes,” then the patient qualifies for the TADM system 9, as shown in block 250. If the determination is “no,” then the patient does not qualify for the TADM system 9, as shown in block 270.

FIG. 4 illustrates a non-limiting illustrative embodiment of a flow chart that provides a more detailed illustration of the global goals module (GGM 220), block 220 of FIG. 3. The global goals 310 include, but are not limited to, patient category focus goals and organizational category focus goals. The patient category focus goals and organizational category focus goals can include sub-goals such as, but not limited to, disease category sub-focus goals. More specifically, the focus goals 310 may include parameters such as, but are not limited to, improving the quality of healthcare, reducing costs, and promoting health education and knowledge. The organization can determine the global goals 310 and can select one or more category focus goals. FIG. 4 illustrates two global goals that an organization can select. It should be noted that an organization can select more than one category focus goal (e.g. patient and organizational category focus goals). A non-limiting example includes, but is not limited to, subsequently performing a patient category focus goal analysis then an organizational category focus goal analysis or vice versa. In any event, a person skilled in the art would understand that various combinations are feasible. In addition, each global goal or sub-goal includes parameters that can be determined and set by the organization.

Another non-limiting example, as shown in FIG. 4, assesses one focus goal. Therefore, if either the patient or organizational category focus goal, block 320 and 330 respectively, are satisfied, then the global goal is satisfied. Initially, the GGM 220 determines if the patient satisfies the patient category focus goals, as shown in decisional block 320. If the determination is “yes,” then the patient satisfies the patient category focus goals (e.g. global goals). If the determination is “no,” then the patient is re-evaluated and a subsequent decision is made to determine if the patient passes after re-evaluation, as shown in block 350. If the determination in block 350 is “no,” then the patient does not satisfy the global focus goals. If the determination in block 350 is “yes,” then the patient satisfies the global goals as shown in block 340.

Alternatively, if the only global goal 310 is the organizational category focus goal, then the GGM 220 determines if the patient satisfies the organizational category focus goals, as shown in block 330. If the determination in block 330 is “yes,” then the patient satisfies the organizational category focus goals (e.g. global goals), as shown in block 340. If the determination in block 330 is “no,” then the patient is re-evaluated. Thereafter a subsequent determination is made by the GGM 220 to determine if the patient qualifies after re-evaluation, as shown in block 350. If the determination in block 350 is “yes,” the patient satisfies the global goals, as shown in block 340. If the determination in block 350 is “no,” then the patient does not satisfy the global goals, as shown in block 360.

The early recognition and definition of the global goals helps make the TADM system 9 efficacious for the care providing organization. The organization identifies the appropriate global goal paths (e.g. patient category focus goal and organizational category focus goal) because these determine which patients are selected and which patients are excluded. Each organization using the TADM system 9 should select the global focus goals that best fits the business model of the organization.

The patient category focus is a global goal of the GGM 220 that is set specifically in relation to the patient. This should not be confused with a focus on a specific patient, but here the intent is to focus on patients within the organizational purview only. Normally, the patient category focus is on the cost of the patient care and neither the disease nor the specific organizational goals are considered. The patient category focus is on managing the care of the patient, to reduce or maintain the cost of care, or more precisely, selecting the group of patients that is the most cost effective for the organization to service.

The organizational category focus is a global goal of the GGM 220 that is set specifically in relation to the organization (e.g. the business model and business goals). The selection of patients for technology-assisted disease management depends on the ability of the organization to accomplish certain goals and make patient outcomes conform to that process. Generally, cost containment of the organization is one of many goals of the organization.

The disease sub-category focus goal is a sub-focus category global goal of the GGM 220 that focuses on a particular disease category. The disease sub-category can be included in both the patient category focus group as well as the organizational category focus group. However, the disease categories may differ between the two focus category groups. More specifically, the disease category focus, within the patient category focus group, may be on patients that have a particular disease or at a particular stage in a disease. One reason that there is a focus upon a particular disease is that patients within this disease category can be efficiently managed by the organization. Therefore, there is a focus on selecting patients with a particular disease, so that the patient can be effectively managed with the TADM system 9 of the organization. The disease sub-category, within the organizational category focus group, focuses on a particular disease that the organization prefers to treat. This may be due to the specialties of the physicians on staff and/or the business model of the organization. Thus, for reasons related to the particular organization, the organization may use a disease category sub-category of the organizational category focus group to select patients with a particular disease.

The global goals of the GGM 220 of the organization can affect the way patients are selected. The above categories can be used either separately or in combination to suit the need of the organization applying the TADM system 9. Setting the parameters of the GGM 220 allows the organization to focus on which patient data is examined and what criteria are used to select patients. In addition, other goal category focus groups can be selected and the categories listed above are a non-exclusive list, and are shown only as non-limiting examples. One skilled in the art would understand that various category focus groups and category sub-focus groups can be used in numerous combinations and those described above are non-limiting examples.

FIGS. 5A-5C illustrate the patient scoring process 230, as shown in FIG. 3. Scoring criteria include, but are not limited to, such categories as cost of care, disease, utilization, doctor and hospital visits, etc. In all cases, scoring is based on a scale suitable for the organization goal set. Within the organizational goal set, the scoring is based on questions (parameters) from the database. The database includes qualification questions and exemption criteria for patients. The specific questions that may be used are based on the category focus implemented (e.g. organizational or patient category focus group). Scores can remain fixed to the questions within the database for consistency. Which questions are used for implementing the qualifying process, and how many are used is dependent on the needs of the organization. Generally, the greater the number of questions that are used, the more accurate the assessment achieved but at a higher level of intensity required to produce the results. Therefore users will be encouraged to use a small number questions in the initial scoring and qualifying process.

FIGS. 5A-5C illustrate a non-limiting illustrative embodiment of the patient scoring module 230 (PSM 230). Decisional step 402 determines if the patient is currently in the TADM system 9. If the decision is “no,” PSM 230 assigns the patient a score of zero and exists the process 230, as shown in step 404. If the decision is “yes,” PSM 230 assigns the patient a score of four, as shown in step 406. PSM 230 continues to decisional step 408, where it is determined if the patient has been hospitalized in the past twelve months. If the decision in block 408 is “no,” PSM 230 assigns the patient a score of zero, as shown in step 410. If the decision in block 408 is “yes,” then step 412 in PSM 230 determines if the patient has been hospitalized more than one time in the past twelve months. If the decision in block 412 is “no,” PSM 230 assigns a score of 3 to the patient, as shown in step 414. If the decision in block 412 is “yes,” then step 416 of PSM 230 determines if the patient has been hospitalized more than two times. If the decision in block 416 is “no,” then PSM 230 assigns the patient a score of six, as shown in step 418. If the decision in block 416 is “yes,” PSM 230 assigns the patient a score of nine, as shown in step 420. Steps 410, 414, 418, and 420 flow into decisional step 422, where PSM 230 determines if the patient has visited the emergency room in the past twelve months. If the decision in block 422 is “no,” PSM 230 assigns the patient a score of zero, as shown in FIG. 5B, step 432. If the decision in block 422 is “yes,” then PSM 230 determines in decisional step 424 if the patient has visited the emergency room more than one time in the last twelve months. If the decision in block 424 is “no,” PSM 230 assigns the patient a score of three, as shown in step 426. If the decision in block 424 is “yes,” then PSM 230 determines in decisional step 428 if the patient has visited the emergency room more than three times in the last twelve months. If the decision in block 428 is “no,” then PSM 230 assigns the patient a score of six, as shown in step 430. If the decision in block 428 is “yes,” PSM 230 determines in decisional step 436, FIG. 5B, if the patient has visited the emergency room more than five times in the last twelve months. If the decision in block 436 is “no,” PSM 230 assigns the patient a score of six, as shown in step 438. If the decision in block 436 is “yes,” PSM 230 assigns the patient a score of eight, as shown in step 440.

Steps 432, 426, 430, 438, and 440 flow into decisional step 434, where PSM 230 determines if the patient has visited a physician in the last twelve months. If the decision in block 434 is “no,” PSM 230 flows to step 456, which will be discussed below. If the decision in block 434 is “yes,” PSM 230 determines in decisional step 442 if the patient has visited a physician more than five times in the last twelve months. If the decision in block 442 is “no,” PSM 230 assigns the patient a score of four, as shown in step 444. If the decision in block 442 is “yes,” then PSM 230 determines in decisional step 446 if the patient has been to a physician more than eleven times. If the decision in block 446 is “no,” then PSM 230 assigns the patient a score of six, as shown in step 448. If the decision in block 446 is “yes,” PSM 230 determines in decisional step 450 if the patient has been to the physician more than seventeen times. If the decision in block 450 is “no,” PSM 230 assigns the patient a score of eight, as shown in step 452. If the decision in block 450 is “yes,” PSM 230 assigns the patient a score of ten, as shown in step 454.

Steps 434, 444, 448, 452, and 454 flow into decisional step 456, where PSM 230 determines if the cumulative score of the patient is greater than ten. If the decision in block 456 is “no,” then PSM 230 flows into block 464, which is discussed in more detail below. If the decision in block 456 is “yes,” PSM 230 determines, in decisional step 458, if the patient can perform the basic acts of life of daily living. If the decision in block 458 is “no,” then PSM 230 flows into block 464. If the decision in block 458 is “yes,” PSM 230 determines in decisional step 460 if the patient is severely mentally impaired. If the decision in block 460 is “yes,” then PSM 230 flows into a block 464. If the decision in block 460 is “no,” PSM 230 determines in decisional step 462 if there is a severe communications impediment. If the decision in block 462 is “yes,” then PSM 230 flows into block 464. If the decision in block 462 is “no,” then the patient satisfies the patient scoring module 466. Blocks 456, 458, 460, and 462 flow into block 464, which determines if the patent qualifies after re-evaluation. If the determination in block 464 is “no,” then PSM 230 determines that the patient does not qualify for the TADM system 9, in block 420. If the determination is “yes,” then PSM 230 determines that the patent qualifies 466 for the TADM system 9. It would be known to one skilled in the art that additional criteria could be used determine if a patient satisfies the patient scoring module. In addition, it would be clear to one skilled in the art to use different scoring numbers or a different order of the steps in the flow chart above and FIGS. 5A-5C are merely a non-limiting illustrative example.

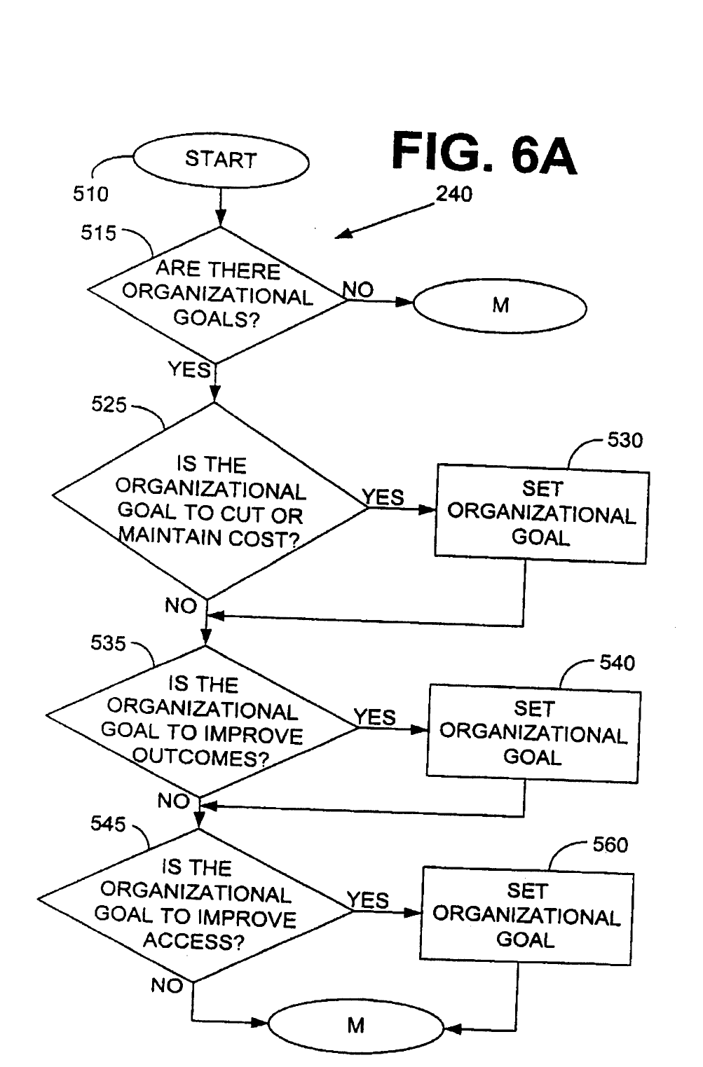

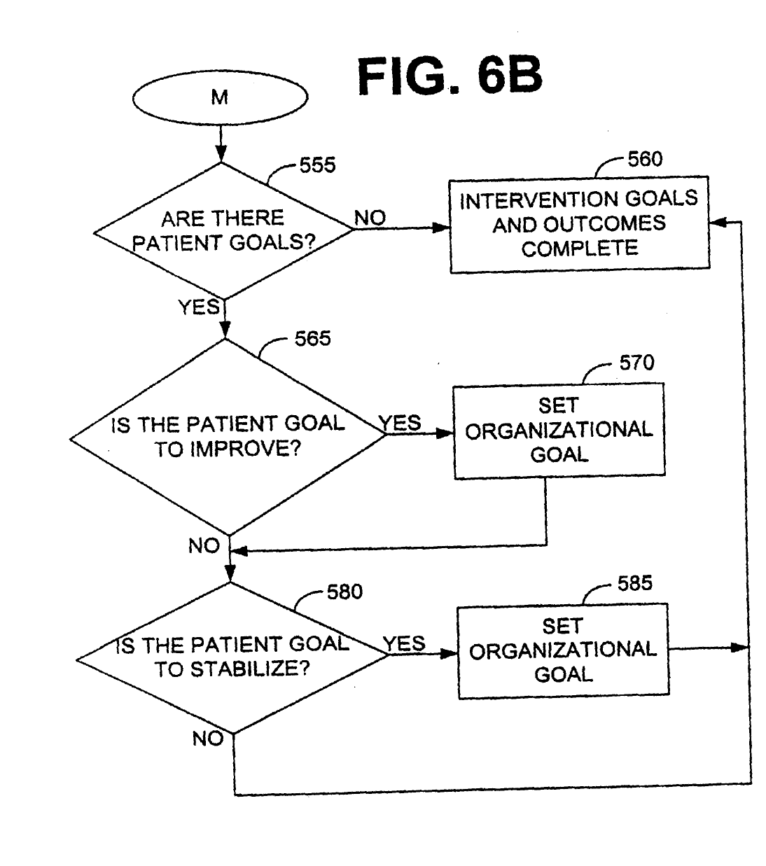

FIGS. 6A and 6B illustrate a non-limiting illustrative embodiment of a flow chart of the intervention goals and outcome module (IGOM 240), as shown in block 240 in FIG. 3. The intervention goals and outcomes for each patient can be determined by the patient diagnosis. The goals are tailored for the patient based on the initial assessment and can be modified based on progress during the implementation of the TADM system 9. The progress toward each intervention goal is measured and monitored each time a visit intervention is completed. If the patient is not progressing as desired or if other medical conditions arise, the parameters of the IGOM 240 can be adjusted as needed.

FIGS. 6A-B illustrate the IGOM 240 in further detail. The IGOM 240 applies specific goals toward specific patients. This is in contrast to GGM 220, which applies global goals towards all patients. In decisional block 515, the IGOM 240 determines if there are organizational goals. If the determination in block 515 is “no,” then the flow chart flows into FIG. 6B. If the determination in block 515 is “yes,” then IGOM 240 determines if the organizational goal is to cut or maintain costs, as shown in block 525. If the determination in block 525 is “yes,” then IGOM 240 sets the organizational goal to cut or maintain organization costs, as shown in block 530. Block 530 flows into block 535, which is discussed below. If the determination in block 525 is “no,” then the IGOM 240 determines if an organizational goal is to improve outcome goals, as shown in block 535. If the determination in block 535 is “yes,” then IGOM 240 sets an organizational goal to improve outcome, as shown in block 540. Block 540 flows into block 545, which is discussed below. If the determination in decisional block 535 is “no,” then IGOM 240 determines if the organizational goal is to improve access to the TADM system 9, as shown in block 545. If the determination is “no,” then the flow chart flows into FIG. 6B. If the determination is “yes,” then IGOM 240 sets an organization goal to improve access, as shown in block 560. Block 560 then flows into FIG. 6B.

FIG. 6B is a continuation of IGOM 240 illustrated in FIG. 6A. Block 515, 545, and 560 of FIG. 6A flow into block 555 of FIG. 6B. Decisional block 555 determines if there are any patient goals. If the determination is “no,” then IGOM 240 is complete, as shown in block 560. If the determination is “yes,” then the IGOM 240 determines if the patient goal is to improve treatment, as shown in block 565. If the determination in block 565 is “yes,” then IGOM 240 sets a patient goal to improve treatment, as shown in block 570. Block 570 flows into block 580, which is described below. If the determination is “no,” then IGOM 240 determines if the patient goal is to stabilize, as shown in block 580. If the determination in block 580 is “no,” then IGOM 240 is complete. If the determination is “yes,” then IGOM 240 sets a patient goal to stabilize, as shown in block 585. Block 585 flows into block 560, which indicates that IGOM 240 is complete.

The TADM system 9 includes the feature of resetting parameters in one or more of the modules (e.g. GGM 220, PSM 230, and IGOM 240). The parameters of the modules can be reset after assessing the patients that are or have been included and participated in the TADM system 9. If the assessment yields unsatisfactory results then appropriate module parameters can be reset, thereby enabling the TADM system 9 to produce the best results for participating organizations.

The TADM system 9 further includes the features of allowing the care provider to select the product (e.g. device) that can be used to treat the patient by using the PQSP 10. In some cases the category focus group (e.g. disease category) dictates the product to be used. In some other cases, however, there will be either two or more products that can be applied. The criteria within the category focus groups can be designed to assist in the product selection process. The PQSP 10 can also provide assistance to the care provider to adjust the product suite to best serve the business model of the organization.

The following is a non-limiting illustrative example that depicts how a patient data set that includes all of the relevant information is assessed by the TADM system 9 using the PQSP 10. This assessment can apply when the organizational focus goal is either on the patient or the organizational category focus module. The initial set of patients to be evaluated can be described by the set {ALL PATIENTS}, 1^{st} set. The global goal setting process would then eliminate some of those patients in the 1^{st} set through the application of the goals of the category focus module, hereinafter termed goal filters. The goal filter includes one or more parameters for accepting or rejecting a patient and can include any appropriate parameters as determined by how the particular organization configures the category focus modules. There may be one or more goal filters for each category focus group. Then the subsequent set of patients can be described by the set {GOAL ACCEPTABLE PATIENTS}, 2^{nd} set. In other words, the patients that meet the screening criteria of the goal focus categories modules are included in the 2^{nd} set.

The following is a non-limiting illustrative example that depicts the PQSP 10 when a disease sub-category focus group is included in the category focus module (e.g. in the patient or organizational category focus module). The set of patients is assessed by the goal rd filter creating a patient set described as {ALL PATIENTS WITH THAT DISEASE}, 3^{rd} set. The disease sub-category focus data filter can select patients based on which category focus module is selected. Further, the filter is capable of filtering based on one or more types of diseases and/or various stages of one or more diseases. In other words, the 3^{rd} set generally describes a set of patients that have a similar disease. The global goal setting process is then complete.

Generally, the next assessment of the PQSP 10 is application of the patient scoring module. The 2^{nd} set can be assessed using the objective patient scoring module to obtain two subsets described as sets {PASSING SCORE PATIENTS} and {FAILING SCORE PATIENTS}, 4^{th} and 5^{th} sets, respectively. In other words, the patients that have a passing patient score are included in the 4th set. In addition, patients that have a failing score can be re-evaluated to determine if they should be in the qualified patient set and that set would be described as {REASSESSED FAILING SCORE PATIENTS} 6^{th} set.

Alternatively, the 3^{rd} patient set, the patient set assessed using the disease subcategory group, can be assessed using the patient scoring module to produce the following two subsets: {PASSING SCORE PATIENTS WITH A PARTICULAR DISEASE} and {FAILING SCORE PATIENTS WITH A PARTICULAR DISEASE}, 7^{th} and 8^{th} sets, respectively. In addition, patients that have a failing score can be re-evaluated to determine if they should be given the qualified patient set, where that set would be described as {REACCESSED FAILING SCORE PATIENTS WITH A PARTICULAR DISEASE}, 9^{th} set.

Generally, after the patient set has been scored, the patient set is evaluated with regard to intervention goals and outcomes. A non-limiting example of this aspect of an embodiment of the present invention would be to access the 4^{th} patient set based on the intervention goals and outcomes organizational goals, which are a set of specific organizational goals for specific types of patients. This would produce a 10^{th} patient set, {PASSING INTERVENTION GOALS AND OUTCOMES ORGANIZATIONAL GOALS PATIENT}. One additional example would be to access the 4^{th} patient set based on the intervention goals and outcomes patient goals, which are a set of specific patient goals for th specific types of patients. This would produce an 11^{th} patient set {PASSING INTERVENTION GOALS AND OUTCOMES PATIENT GOALS PATIENT}. It should be noted that both the intervention goals and outcomes goal categories can be applied to the same patient set sequentially, where either goal category can be assessed first or second. In other words, the 4^{th} patient set can be assessed based on the intervention goals and outcomes organizational goals to produce the 12^{th} patent set, then access the 12^{th} set based on the intervention goals and outcomes patient goals to produce another patient set. Further, one or both of the intervention goals and outcomes categories can be used to assess other patient sets including, but not limited to, the 6^{th} set, the 7^{th} set, or the 9^{th} set.

It should be noted that the hereinabove examples are only illustrative non-limiting examples of only a few embodiments of the present invention. Further, a person skilled in the art would understand that many alternative embodiments are possible and the order of the assessment can be altered.

The patient groups can be organized into an outcome matrix. In general and depending on the particular setup, the outcome matrix can be represented as follows: {QUALIFIED PATIENTS}={ALL PATIENT}∩{ORGANIZATIONAL GOAL ACCEPTABLE PATIENTS}∩{PATIENT GOAL ACCEPTABLE PATIENTS}{PASSING SCORE PATIENTS}∩{REASSESSED FAILING SCORE PATIENTS}. It should be noted that this is only an illustrative non-limiting example and one skilled in the art would understand that many other outcomes matrixes are possible.

After the patient qualifies for the TADM system 9 using the PQSP 10, the patient or responsible party is contacted and the TADM system 9 is explained to the appropriate party and consent to be entered into the TADM system 9 is requested. Thereafter, if consent is received, the physician is contacted, appropriate monitoring equipment is selected, and baseline parameters are set and the patient is entered into the TADM system 9.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims. One skilled in the art would understand that the foregoing embodiments are merely illustrative examples and that many other embodiments are capable of being performed.

We claim the following:

1. A method for qualifying and selecting patients to be included in a technology-assisted disease management (TADM) system, comprising the steps of:
receiving an input associated with the patient;
assessing said input using a global goal module that is capable of defining the goals of the organization; and
determining if said input is a qualified input based upon said assessment, where the patient associated with said qualified input is included in the TADM system.

2. The method of claim 1, further comprising the step of assessing said input using a patient scoring module that is capable of providing the score of said input.

3. The method of claim 1, further comprising the step of assessing said input using an intervention goals and outcome module.

4. A method for qualifying and selecting patients to be included in the technology-assisted disease management (TADM) system, comprising the steps of:
receiving an input associated with the patient;
assessing said input using at least one qualifying module, said qualifying module having at least one predetermined parameter; and
determining if said input is a qualified input based upon said assessment, where the patient associated with said qualified input is included in the TADM system.

5. The method of claim 4, further comprising the steps of:
re-evaluating a non-qualified input; and
determining if said non-qualified input is a re-evaluated qualified input, where the patient associated with said re-evaluated qualified input is included in the TADM system.

6. The method of claim 4, wherein the of step of assessing said input using at least one qualifying module further includes the step of assessing said input using a global goal module.

7. The method of claim 6, wherein the of step of assessing said input using said global goal module further includes the step of assessing said input using a patient category focus module.

8. The method of claim 6, wherein the step of assessing said input using said global goal module further includes the step of assessing said input using an organizational category focus module.

9. The method of claim 4, wherein the of step of assessing said input using at least one qualifying module further includes the step of assessing said input using a patient scoring module.

10. The method of claim 4, wherein the of step of assessing said input using at least one qualifying module further includes the step of assessing said input using an intervention goals and outcome module.

11. The method of claim 4, further comprising the step of selecting monitoring equipment based on said assessment of said input.

12. The method of claim 4, further comprising, the steps of:
receiving a qualified outcome input associated with the patient outcome of being included in the TADM system;
assessing said outcome qualified input to determine if it is unsatisfactory, said determination based upon the patient outcome after being included in the TADM system; and
resetting at least one of said parameters if said qualified outcome input is determined to be unsatisfactory.

13. A system for qualifying and selecting patients to be included in a technology-assisted disease management (TADM) system, comprising:
means for receiving an input associated with the patient;
means for assessing said input using at least one qualifying module, said qualifying module having at least one predetermined parameter; and
means for determining if said input is a qualified input based upon said assessment, where the patient associated with said qualified input is included in the TADM system.

14. The system of claim 13, further comprising:
means for receiving a qualified outcome input associated with the patient outcome of being included in the TADM system;
means for assessing said outcome qualified input to determine if it is unsatisfactory, said determination based upon the patient outcome after being included in the TADM system; and
means for resetting at least one of said parameters if said qualified outcome input is determined to be unsatisfactory.

15. The system of claim 13, further comprising:
means for re-evaluating a non-qualified input; and
means for determining if said non-qualified input is a re-evaluated qualified input, where the patient associated with said re-evaluated qualified input is included in the TADM system.

16. A system for qualifying and selecting patients to be included in a technology-assisted disease management (TADM) system, comprising:
means for receiving an input associated with the patient;
means for assessing said input using a global goal module that is capable of defining the goals of the organization; and
means for determining if said input is a qualified input based upon said assessment, where the patient associated with said qualified input is included in the TADM system.

17. A method for use in a computer system for qualifying and selecting patients to be included in a technology-assisted disease management (TADM) system, comprising the steps of:
receiving an input associated with the patient;
assessing said input using a global goal module that is capable of defining the goals of the organization; and
determining if said input is a qualified input based upon said assessment, where the patient associated with said qualified input is included in the TADM system.

18. A method for use in a computer system for qualifying and selecting patients to be included in a technology-assisted disease management (TADM) system, comprising the steps of:
receiving an input associated with the patient;
assessing said input using at least one qualifying module, said qualifying module having at least one predetermined parameter; and
determining if said input is a qualified input based upon said assessment, where the patient associated with said qualified input is included in the TADM system.

19. The method of claim 18, further comprising the steps of:
re-evaluating a non-qualified input; and
determining if said non-qualified input is a re-evaluated qualified input, where the patient associated with said re-evaluated qualified input is included in the TADM system.

20. The method of claim 18, further comprising the steps of:
receiving a qualified outcome input associated with the patient outcome of being included in the TADM system;
assessing said outcome qualified input to determine if it is unsatisfactory, said determination based upon the patient outcome after being included in the TADM system; and
resetting at least one of said parameters if said qualified outcome input is determined to be unsatisfactory.

21. A computer readable medium for qualifying and selecting patients to be included in a technology-assisted disease management (TADM) system, comprising:
logic configured to receive an input associated with the patient;
logic configured to assess said input using at least one qualifying module, said qualifying module having at least one predetermined parameter; and
logic configured to determine if said input is a qualified input based upon said assessment, where the patient associated with said qualified input is included in the TADM system.

22. The computer readable medium of claim 21, further comprising:
logic configured to re-evaluate a non-qualified input; and
logic configured to determine if said non-qualified input is a re-evaluated qualified input, where the patient associated with said re-evaluated qualified input is included in the TADM system.

23. The computer readable medium of claim 21, further comprising:
logic configured to receive a qualified outcome input associated with the patient outcome of being included in the TADM system;
logic configured to assess said outcome qualified input to determine if it is unsatisfactory, said determination based upon the patient outcome after being included in the TADM system; and
logic configured to reset at least one of said parameters if said qualified outcome input is determined to be unsatisfactory.

24. A computer readable medium for qualifying and selecting patients to be included in a technology-assisted disease management (TADM) system, comprising:
logic configured to receive an input associated with the patient;
logic configured to assess said input using a global goal module that is capable of defining the goals of the organization; and
logic configured to determine if said input is a qualified input based upon said assessment, where the patient associated with said qualified input is included in the TADM system.
